(19) United States
(12) Patent Application Publication
(10) Pub. No.: US 2017/0050856 A1
(43) Pub. Date: Feb. 23, 2017

(54) Re-Dispersible Dry Graphene Powder

(71) Applicants: Tian Ming, Cambridge, MA (US); Cheng-Te Lin, Cambridge, MA (US); Jing Kong, Winchester, MA (US)

(72) Inventors: Tian Ming, Cambridge, MA (US); Cheng-Te Lin, Cambridge, MA (US); Jing Kong, Winchester, MA (US)

(73) Assignee: Massachusetts Institute of Technology, Cambridge, MA (US)

(21) Appl. No.: 15/239,901

(22) Filed: Aug. 18, 2016

Related U.S. Application Data
(60) Provisional application No. 62/206,527, filed on Aug. 18, 2015.

(51) Int. Cl. C01B 31/04; B01F 17/00; B01J 2/00; C09C 1/46

(52) U.S. Cl. CPC C01B 31/0469; C01B 31/0484; C09C 1/46; B01F 17/0007; B01J 2/006

(57) ABSTRACT

A re-dispersible, dry graphene powder can be formed by producing a solution of graphene sheets in solvent, adding surfactant to the solution, and then drying the solution to produce dry graphene sheets coated with surfactant.

### RELATED APPLICATION

This application claims the benefit of U.S. Provisional Application No. 62/206,527, filed 18 Aug. 2015, the entire content of which is incorporated herein by reference.

### BACKGROUND

Graphene is an allotrope of carbon with a two-dimensional atomic-scale hexagonal lattice structure in which each carbon atom forms a vertex in the lattice structure. Each carbon atom has four bonds, one σ bond with each of its three in-plane neighbors and one π bond that is oriented out of plane.

Due to its unique atomically thin two-dimensional lattice structure constructed with sp²-bonded carbons, graphene can exhibit extraordinary properties, such as high charge carrier mobility (over 2×10⁵ cm²·V⁻¹·s⁻¹ at an electron density of 2×10¹¹ cm⁻²), high thermal conductivity (over 3000 W·m⁻¹·K⁻¹), and exceptional Young modulus values (over 0.5 TPa). Furthermore, its high surface area, theoretically predicted as being over 2600 m²·g⁻¹ and experimentally measured to be 400-700 m²-g⁻¹ has also made graphene an attractive material. Such properties render graphene advantageous for use in numerous emerging applications in a broad range of fields, such as flexible electronics, photonics, energy conversion and storage, electrically/thermally conductive inks, and functional polymer composites.

For this reason, great efforts have been spent in the production of graphene. One route has been the development of defect-free, single-layer graphene sheets with the largest possible lateral size. Toward this goal, graphene can be obtained in the form of very-high-quality sheets produced in limited quantities using bottom-up methods, including chemical vapor deposition, annealing SiC substrates, and building up graphene from molecular building blocks. On the other hand, top-down methods for generating graphene from graphite still dominate in large-volume production of graphene in the scale from grams to kilograms to tons. These methods generate exfoliated graphene and have been widely used in making graphene composites.

The exfoliation of graphite into graphene requires counteracting the enormous van der Waals attraction between graphite layers, which is equivalent to an interlayer binding energy of about 1.65 eV·nm⁻². Methods for achieving exfoliation include ultra-sonication or shearing-mixing-assisted exfoliation in organic solvent or surfactant solution; electrochemical exfoliation of graphite in electrolyte; and chemical reduction of exfoliated graphite oxide, with defect concentrations from low to high. One of the most well-known methods is to oxidize and exfoliate graphite into graphene oxide, then reduce the graphene oxide sheet to obtain graphene. Graphene produced via this process is call reduced graphene oxide (r-GO). However, compared to pristine graphene that is free of defects, graphene obtained from oxidation shows significantly reduced electrical properties owing to the considerable disruption by high concentration of defects, e.g., dangling bonds and out-of-plane sp³-carbon bonds.

A colloidal solution with pristine graphene that is free of defects, however, is intrinsically unstable. The exfoliation of graphite into graphene requires counteracting the enormous van der Waals attraction between graphite layers, which is equivalent to an interlayer binding energy of ˜1.65 eV·nm⁻². After exfoliation, the solvent-graphene interaction needs to balance the inter-sheet attractive forces, or the graphene layers tend to aggregate in order to re-establish the graphitic structure and to minimize surface free energy. As shown in FIG. 1, dispersed electrochemically exfoliated graphene 12, over time, precipitates to form a settled aggregate 14 in either N-methylpyrrolidone (NMP) or 30 wt % isopropyl alcohol (IPA) aqueous solution, which have been recognized as being good solvents for graphene exfoliation and dispersion.

The precipitation process follows a multi-component exponential decay (as shown by the plots of light absorbance through the bulk of 30-weight-% IPA aqueous solution 16 and through 30-weight-% aqueous solution NMP aqueous solution 18 over time in FIG. 2), wherein less absorbance is indicative of increased graphene aggregation and settling, which agrees with previous reports. Introducing defects, such as out-of-plane sp³ carbon bonds, increases the solubility of the graphene but degrades its charge transport, thermal transport and mechanical properties dramatically. More systematic studies from both experimental and theoretical perspectives have shown that for freshly prepared graphene NMP colloidal solution, more than half of the monolayer, bilayer and trilayer graphene sheets aggregate into thicker graphite flakes within the first ten days. Charging the graphene sheets by ion adsorption in aqueous solution slows down but cannot suppress the aggregation. Studies of graphene in sodium cholate surfactant aqueous solution have shown similar aggregation behavior as in NMP. The gradual aggregation of freshly prepared graphene colloidal results in inconsistence in experimental results from time to time, from people to people and from lab to lab. For practical applications, considering that the storage and transportation of graphene solution generally takes weeks or even longer, the aggregation of the graphene tragically destroys the value of the product. More importantly, the solution phase is not only not able to stabilize the graphene colloids, it also dramatically increases the storage and transportation cost by taking up the majority of the product volume and weight.

Efforts have been spent on slowing down the re-stacking of graphene solution. Recently, Smith, et al., “The Importance of Repulsive Potential Barriers for the Dispersion of Graphene Using Surfactants,” 12 New J. Phys. 125008 (2010), investigated the dispersion of graphene using 12 ionic and non-ionic surfactants; they found that a larger absolute zeta potential is critical for better dispersion and slower aggregation. From a reaction kinetics point of view, this re-stacking process is also dependent on graphene concentration, where a lower graphene concentration leads to less collision and slower restacking. Ultra-sonication produces a graphene solution with concentration up to 15 mg/ml. This concentration may be too low for using the solution as a precursor for making graphene composites. Concentrating the solutions to a concentration more than 10 times greater or even drying the solutions into graphene dry powder is essential in most cases for making graphene composites.

Concentrating or drying graphene solution makes the re-stacking effect significant, which cancels the great effort spent on the exfoliation processes. Once this happens, long-term ultra-sonication is applied again to transfer the re-stacked graphene into monolayer or few-layer graphene. The aggregation of graphene in solution is more problematic for industrial storage and transport. On one hand, a solution with a low graphene concentration demands significantly more transportation efforts, with the solvent being the majority of what is being transported. On the other hand, long-term storage or transportation destroys the value of the graphene products due to the aggregation of graphene into multi-layer or even graphite.

In short, graphene flakes in their colloidal solution tend to restack and precipitate during their storage, leading to inconsistency in their following applications. Moreover, the solvent occupies the major weight and volume of the solution and, therefore, significantly increases the transportation cost.

### SUMMARY

A re-dispersible dry graphene powder and methods for its production are described herein, where various embodiments of the compositions and methods may include some or all of the elements, features and steps described below.

As described herein, a re-dispersible dry graphene powder can be produced by a method comprising producing a solution of graphene sheets in solvent; adding surfactant to the solution; and then drying the solution to produce dry graphene sheets coated with surfactant that stabilizes the dry graphene sheets.

The re-dispersible surfactant-stabilized dry graphene powder can remedy the problem of re-stacking, described above, while allowing for storage transport of the graphene in a very concentrated form. Moreover, the graphene powder can be quickly and easily re-dispersed (e.g., with just one ultra-sonication treatment). Additionally, the surfactant can act simultaneously both as the exfoliation agent and as the stabilization agent. Further still, the re-dispersible graphene dry powder offers not only better weight economy for storage and transport, but also better usability for making composites.

### BRIEF DESCRIPTION OF THE DRAWINGS

FIG. 1 is a photographic image showing a dispersion 12 of graphene flakes in 30 weight-percent (wt %) isopropyl alcohol (IPA) and N-methylpyrrolidone (NMP) and settled graphene precipitate 14 after more than 70% of the from the dispersion 12 of graphene flakes precipitate within 30 days.

FIG. 2 shows the light absorbance through the bulk of 30-weight-% IPA aqueous solution 16 and through 30-weight-% aqueous solution NMP aqueous solution 18 over time.

FIGS. 3 and 4 demonstrate the re-dispersible graphene dry powder, which can be well re-dispersed into 30 wt % IPA or other effective solvent for graphene. The graphene is shown in dispersed 12 and dry 20 forms. FIGS. 5 and 6 characterize a graphene sample prepared by electrochemical exfoliation from graphite. FIG. 5 is an optical microscopic image of a graphene sample deposited on a SiO₂/Si wafer. FIG. 6 is an atomic force microscopic image of the same graphene sample as shown in FIG. 5.

FIG. 7 provides a statistical histogram of flake thicknesses measured from 100 graphene flakes from the sample shown in FIGS. 5 and 6.

FIG. 8 is a Raman spectrum of the graphene sample shown in FIGS. 5 and 6 deposited on cover glass.

FIG. 9 is an the x-ray photoelectron spectroscopy (XPS) spectrum of the graphene sample shown in FIGS. 5 and 6, where only the range covering the Cls peak is plotted and fitted.

FIG. 10 shows an optical absorbance spectrum of the graphene sample shown in FIGS. 5 and 6 from 200 to 900 nm.

FIGS. 11 and 12 show scanning electron microscopic images, respectively, of dry graphene obtained by freeze-drying and by solvent thermal evaporation.

FIG. 13 shows the re-dispersion of graphene dry products in water and 30-wt % IPA.

FIG. 14 shows the corresponding re-dispersion ratio for the graphene dry products.

FIG. 15 is a plot showing that the re-dispersed graphene has a similar thickness distribution compared to the pristine sample.

FIG. 16 is a transmission electron microscopic (TEM) image and FIG. 17 a high-resolution TEM image of the graphene flake after drying and re-dispersion.

FIG. 18 plots the measured re-dispersion ratio for the graphene flakes as a function of added sodium deoxycholate (SDOC).

FIG. 19 shows that, after addition of SDOC, the re-dispersed graphene flakes show a thickness distribution similar to that of the pristine graphene sample.

FIG. 20 plots the optical absorbance at 650 nm of the re-dispersed solution as a function of graphene concentration before freeze-drying.

FIG. 21 illustrates the interaction between two adjacent graphene flakes 20, modeled as a repulsive steric force and an attractive van der Waals force.

FIG. 22 is a plot of the binding energy of graphene flakes as a function of interlayer distance.

FIG. 23 is a chart showing that insertion of a steric layer between two adjacent graphene flakes dramatically reduces the interlayer binding energy.

FIGS. 24a-h show the affect of surfactant concentration on exfoliation. Absorbance of exfoliated graphite as a function of the concentration for eight different surfactants is plotted, including non-ionic (sodium deoxycholate, sodium cholate, and sodium dodecylbenzenesulfonate, respectively plotted in FIGS. 24a-c), anionic (sodium dodecyl sulfate, cetyltrimethylammonium bromide, PLURONIC P123 poloxamer, and PLUONIC F108 poloxamer, as shown in FIGS. 24d, e, g, and h) and cationic (PLURONIC F127 poloxamer, as shown in FIG. 24f) surfactants.

FIG. 25 compares the re-dispersion performance for different surfactants, wherein the highest absorbance of the exfoliated graphene was selected for each surfactant and plotted as bars 38. The absorbance of the corresponding re-dispersed graphene solution was also plotted for freeze-dried graphene samples 40 and for oven-dried graphene samples 42.

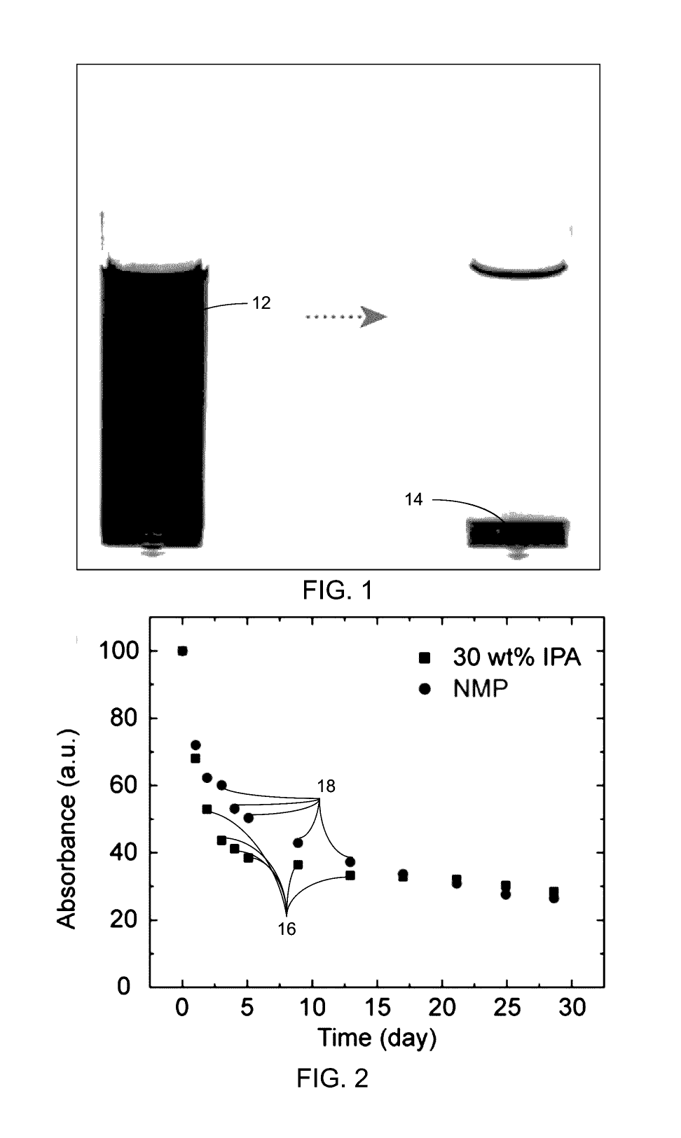

In the accompanying drawings, like reference characters refer to the same or similar parts throughout the different views; and apostrophes are used to differentiate multiple instances of the same or similar items sharing the same reference numeral. The drawings are not necessarily to scale; instead, emphasis is placed upon illustrating particular principles in the exemplifications discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances. Percentages or concentrations expressed herein can represent either by weight or by volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

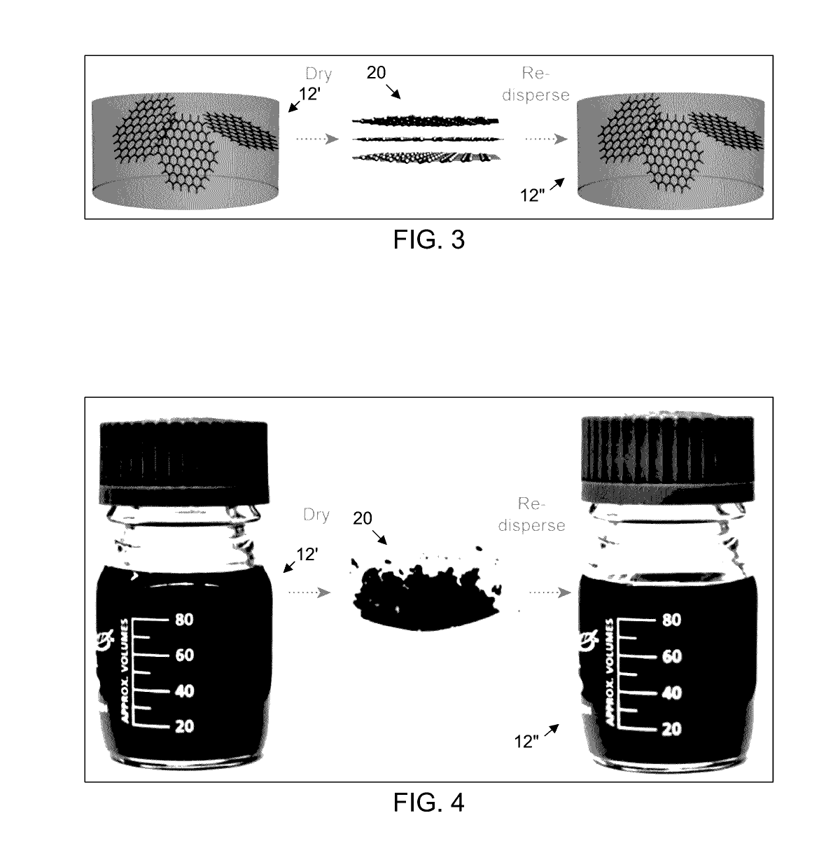

Eliminating the use of solvent for graphene storage and transport and, instead, producing and maintaining the graphene in a dry-powder form represents a significant advancement. Whenever needed, the dry graphene powders 20, as described herein, can be easily redispersed into colloidal solution 12″ with a quality and thickness distribution similar to that of the initial colloidal solution 12′ (as shown in FIG. 3). As described below, approaches are investigated for making redispersible graphene dry powder 20 that can be well dispersed into colloidal solution 12″ by adding the solvent and applying only, e.g., one-minute ultra-sonication or shear mixing (as shown in FIG. 4).

Electrochemically exfoliated (EE) graphene was chosen as a sample material in this study because it balances production yield (32 g per hour), defect concentration (C/O=17.2) and lateral size (several micrometers). The results and conclusions are potentially applicable to graphene ink prepared by other methods. The electrochemically exfoliated graphene was prepared based on a previously reported method [C. Y. Su, et al., “High-Quality Thin Graphene Films from Fast Electrochemical Exfoliation,” 5 ACS Nano 2332-2339 (2011)].

Briefly, graphite flakes (99.9%, #43319 from Alfa Aesar of Ward Hill, Mass., US) were electrolyzed in an aqueous solution with a mixture of 0.2M K₂SO₄ and 0.1M KOH. An alternating bias between +10 and −10 V was applied, each for 5 seconds. The resulting mixture was vacuum filtrated and re-dispersed four times in water first and then twice in 30 wt % isopropyl alcohol (IPA). Finally, the mixture was centrifuged twice at 1000 g for 10 minutes to get rid of bulk graphite. The concentration of the resulting electrolyzed graphene solution 12′ in 30 wt % IPA was adjusted to 1 mg/ml. 30-wt % IPA was used as the solvent due to its low toxicity and high vapor pressure. One tenth of the solution 12′ was oven dried and weighed to obtain the weight concentration, c, of the graphene solution. Absorbance of the solution at 650 nm was measured; and the absorption coefficient, α₆₅₀, of the graphene solution was determined to be 2,230 L g⁻¹ m⁻¹ using the Beer-Lambert law.

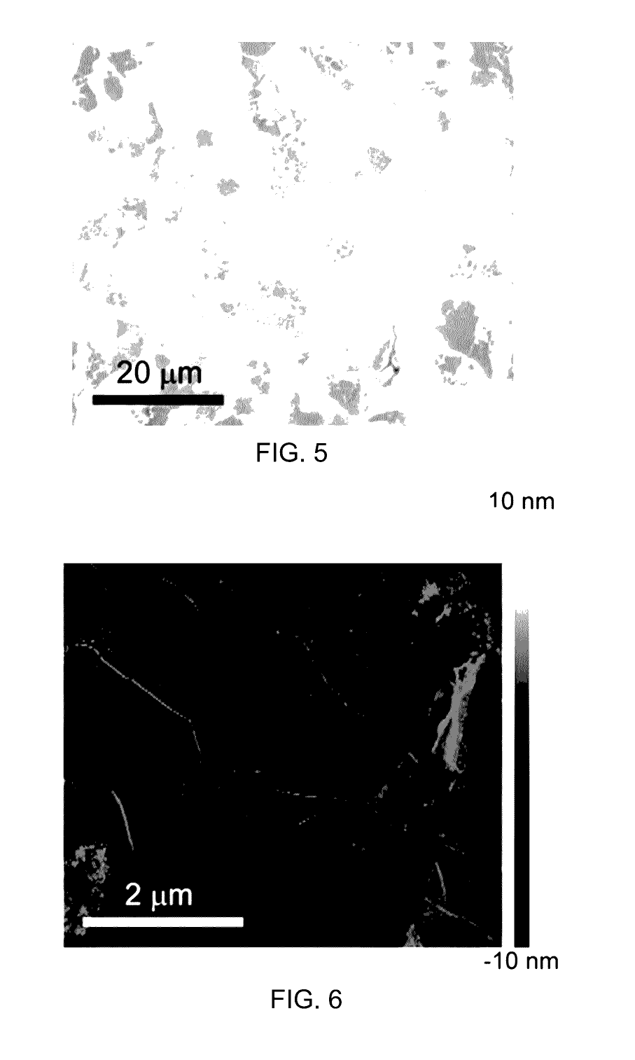

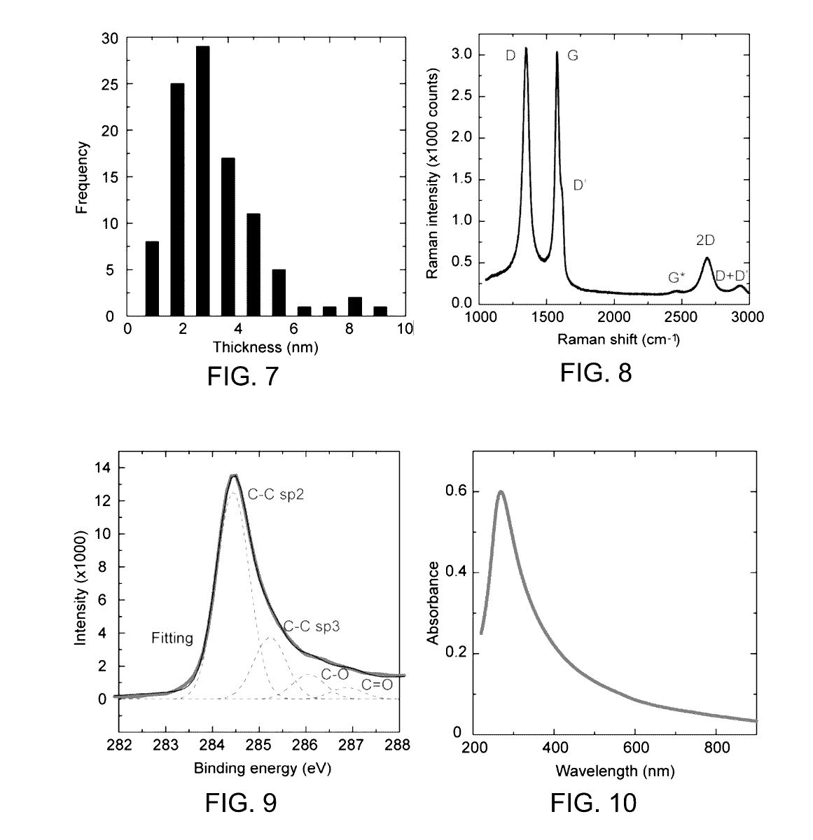

The optical microscopic image of FIG. 5 indicates that the lateral size of the graphene flakes is 4±2 μm. FIG. 6 shows a typical graphene sheet with a thickness of 1.5 nm. The thickness distribution of over 100 randomly selected sheets is plotted in FIG. 7, where the thickness of the sheets in the product is shown to range from 1 nm to 6 nm, with the most probable thickness being 3 nm. The Raman spectrum of FIG. 8 shows intense D, D′, and D+D′ bands, indicating disorders in the graphene lattice. The disorders are attributed to the generation of sp³ C—C bonds, C—O bonds and CO bonds during the exfoliation process, as proved by the x-ray photoelectron spectroscopy (XPS) spectrum shown in FIG. 9. The sp² C—C bond peak contributes to 68% of the total Cls peak area, with the rest taken up by the sp³ C—C bond peak (20%), the C—O bond peak (8%), and the CO bond peak (4%). The graphene solution shows a typical absorption spectrum, as shown in FIG. 10, with a single absorption peak at 269 nm.

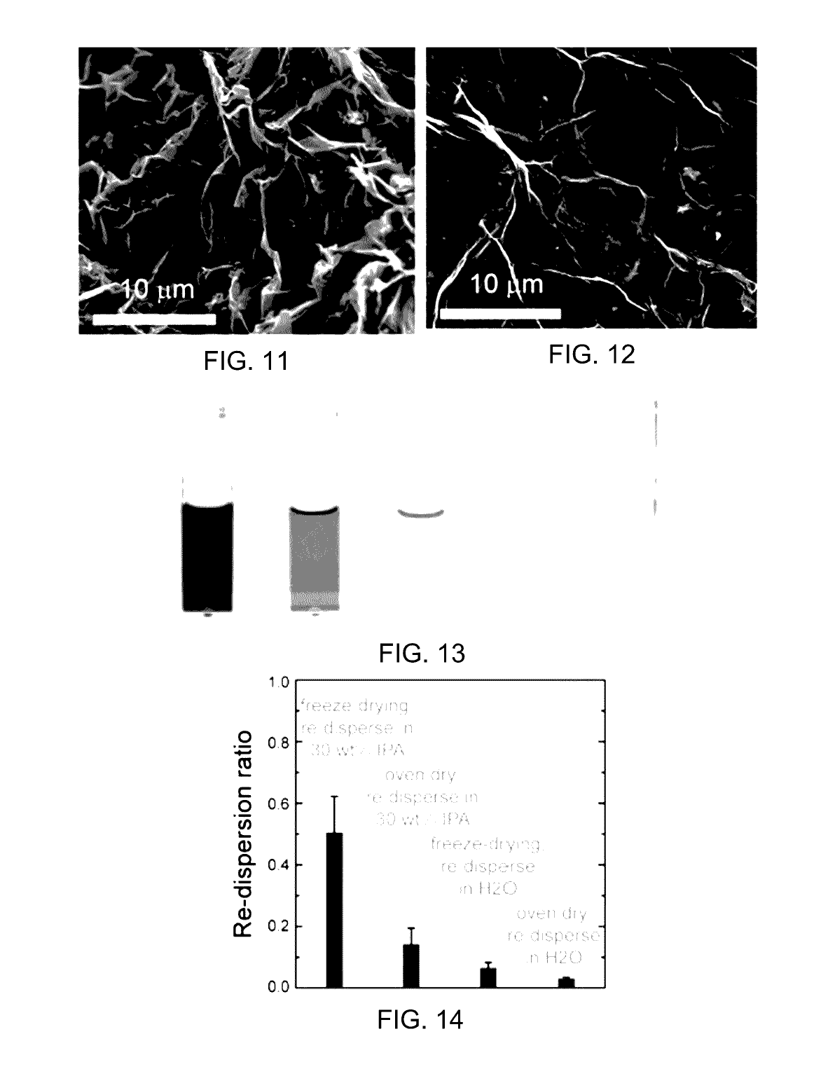

Two different techniques were used to remove the solvent and to thereby transform the graphene into dry powders 20. The techniques include vacuum filtration and solvent thermal evaporation. In a typical re-dispersion experiment, after sonication and before centrifugation, 3 mL of the pristine graphene solution 12′ was transferred to a 15-mL centrifuge tube and frozen in liquid nitrogen. The centrifuge tube was left open, and the frozen solution was then dried using a freeze dry system (from Labconco of Kansas City, Mo., US) working at −80° C. and 0.1 mbar. The pristine graphene solution 12′ was also dried using thermal solvent evaporation in an oven at 60° C., 1 atmosphere for comparison. Scanning electron microscopic images reveal the difference between the resulting dry graphene powders 20. Dry graphene that is produced via freeze-drying exhibits meso-pores with pore sizes in the range of several micrometers (e.g., less than 10 μm, as shown in FIG. 11). Dry graphene samples obtained from solvent thermal evaporation are irregular and dense (as shown in FIG. 12).

The resulting dry powder 20 was added with the same amount of 3-mL 30-wt % IPA; next, ultra-sonication was performed for one minute. The dispersion was centrifuged at a relative centrifugation force of 500 g for 20 minutes, and the supernatant was collected as the re-dispersed graphene solution 12″, as shown in FIG. 13. An initial 0.1-mg/mL graphene solution was also centrifuged, and the supernatant was taken as the control. The re-dispersed graphene solutions 12″ were less opaque than the control sample, indicating a loss of graphene during the re-dispersion process. To quantify the ratio of the graphene that was re-dispersed, the absorbance of the re-dispersed graphene solution was measured at 650 nm and was divided by that of the control sample; the value obtained was taken as the re-dispersion ratio and is plotted in FIG. 14. The solution dried by freeze-drying showed a re-dispersion ratio of 0.5. Vacuum filtration and thermal evaporation led to lower re-dispersion ratios of 0.15 and 0.13, respectively.

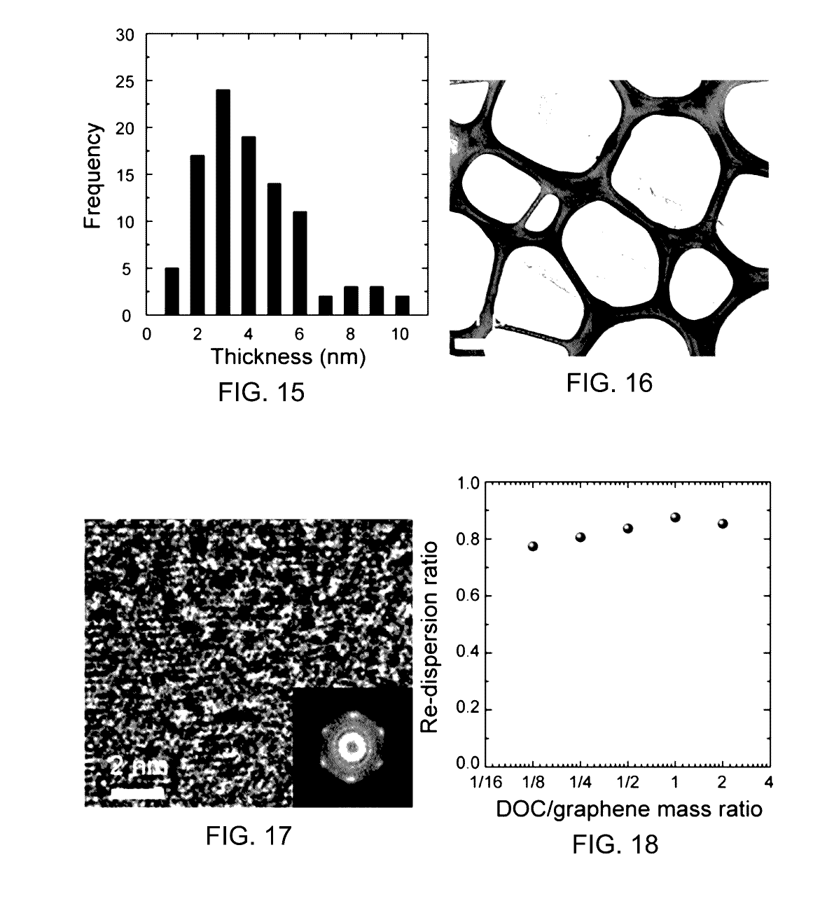

The low re-dispersion of the graphene indicates that the majority of the graphene remains as aggregates after the one minute of ultra-sonication. Extending the sonication period helps to re-disperse the graphene powder but is un-desirable because the sonication fractures the graphene sheets and reduces their aspect ratio, while at the same time increasing processing duration and cost. For the re-dispersed lyophilized graphene powder, the atomic force microscopy (AFM) measurements reveal a maximum thickness probability of 3 nm with a narrow thickness distribution from 1 to 6 nm, as shown in FIG. 15. The transmission electron microscopic (TEM) image of FIG. 16 shows a representative graphene sheet after drying and re-dispersion, the hexagonal lattice can be well resolved under high-resolution TEM, as shown in FIG. 17.

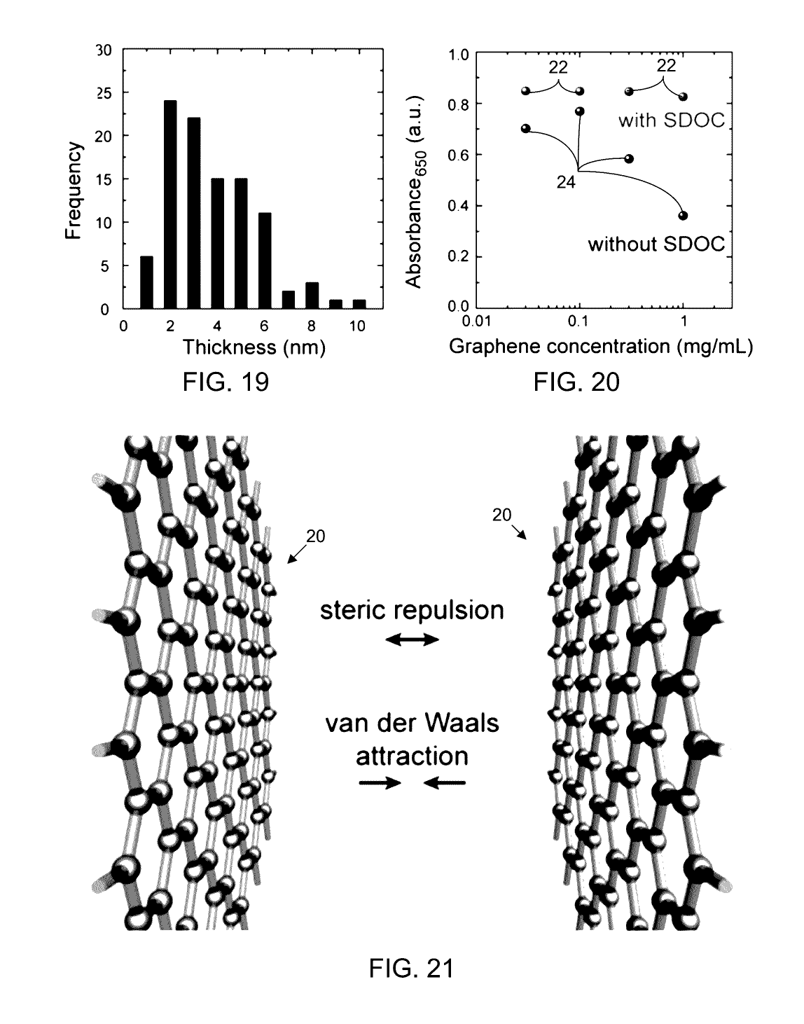

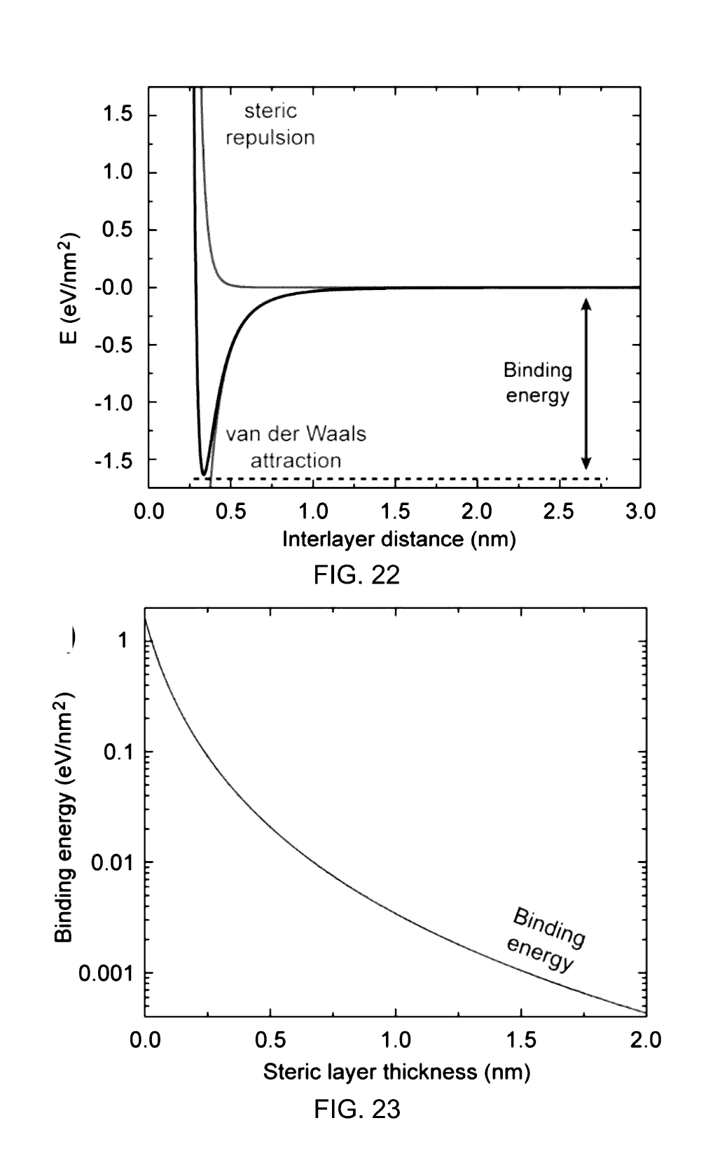

Compared with solvent thermal evaporation, freeze drying offers a better re-dispersion ratio of 0.5. This ratio, however, is still not ideal for practical application. To further improve the re-dispersion of the graphene dry powder 20, surfactant molecules were added to the graphene solution 12′ before drying. The solution with surfactant was ultra-sonicated for one minute and then kept still for ten minutes to enable surfactant adsorption on the graphene to reach equilibrium. The solution 12′ was then dried by freeze-drying, and the dry graphene powder 20 was re-dispersed. The surfactant/graphene weight ratio was varied from ⅛ to 2 to study the re-dispersion as a function of the mass ratio between the surfactant and the graphene. Typically, re-dispersible graphene with a lower amount of stabilizer is more desirable. FIG. 18 shows the re-dispersion ratio of graphene powder added with different amounts of sodium deoxycholate (SDOC) as the surfactant. Intriguingly, adding SDOC at only one-eighth the mass of graphene helps to improve the re-dispersion ratio from 0.50 to 0.78. Adding the same mass of SDOC to graphene makes the powder 89% re-dispersible. The re-dispersed graphene with the existence of SDOC also shows similar thickness distribution as the pristine graphene (as shown in FIG. 19).

Interestingly, the re-dispersion of graphene powder without surfactant depends intensively on the initial concentration of the graphene solution (as shown in FIG. 20). With an initial concentration of 0.1 mg/mL, the graphene powder shows an optimal (or near optimal) re-dispersion of 0.8 without surfactant. Higher or lower initial concentrations gave lower re-dispersion ratios. In contrast, the graphene powder with surfactant shows almost no dependence on the initial concentration of the graphene solution. At a graphene concentration as high as 1 mg/mL, 82% of the graphene can still be re-dispersed.

To better understand the re-dispersion of graphene dry powder, we look into the interlayer binding energy between graphene sheets. The specific binding energy per unit area between parallel graphene sheets can be expressed as the Lennard-Jones potential, E, as follows:

$${E}_{specific} = \frac{{c}_{10}}{{d}^{10}} - \frac{{c}_{4}}{{d}^{4}} , \qquad ( 1 )$$

wherein d is the interlayer distance. The differences in the exponents compared to the traditional Lennard-Jones potential, E=c₁₂/d¹²−c₆/d⁶, compensate for the two-dimensional planar atomic structure of the graphene. For pristine graphene, as shown in FIG. 21, the van der Waals attraction comes from the London dispersion force, and the steric repulsion comes from the Pauli exclusion between 2 pz electrons of carbon atoms from adjacent layers of graphene 20. Parameters, c₁₀ and c₄, are obtained by fitting Eq. 1 with the experimental interlayer distance, d, of 0.335 nm and binding energy, E, of 1.65 eV/nm² as 1.63×10⁻⁶ eV·nm⁸ and 3.08×10⁻² eV·nm², respectively. FIG. 2 plots the interaction energy as a function of interlayer distance.

The magnitude of this binding energy represents the energy that is needed to peel these two graphene sheets 20 apart. In other words, if an easy separation of two graphene sheets 20 is expected, efforts are needed to reduce the interlayer binding energy. Since the van der Waals attraction is a short range interaction and is strongly dependent on the interlayer distance, a small increase in the interlayer distance can dramatically reduce the magnitude of the van der Waals attraction force. This can be achieved by artificially inserting a steric layer between the adjacent graphene sheets 20, which is also called intercalation. We demonstrate this point theoretically by adding a steric thickness parameter, dₛ, into the steric repulsion term in Equation 1.

The interaction can then be written as follows:

$${E}_{s} = \frac{{c}_{10}}{{( d - {d}_{s} )}^{10}} - \frac{{c}_{4}}{{d}^{4}} , \qquad ( 2 )$$

where Eₛ, is the specific binding energy between two graphene layers.

By using this equation, we assume (1) that the steric layer has steric repulsive interaction with both graphene sheets and (2) that the steric layer does not simultaneously have van der Waals interaction with both graphene sheets. In other words, the steric layer mediates the steric repulsion but does not mediate the van der Waals attraction. In this case, the interlayer distance, d, in the steric repulsion term is defined to be larger than dₛ. It is worth notice that increasing the steric layer thickness drastically decreases the interlayer binding energy (as shown in FIG. 23).

For example, a steric layer thickness of only 0.55 nm can diminish the binding energy by two orders of magnitude. Consequently, binding energy can be used as a quantitative parameter for evaluating the re-dispersity of graphene; i.e., a smaller binding energy indicates easier re-dispersion.

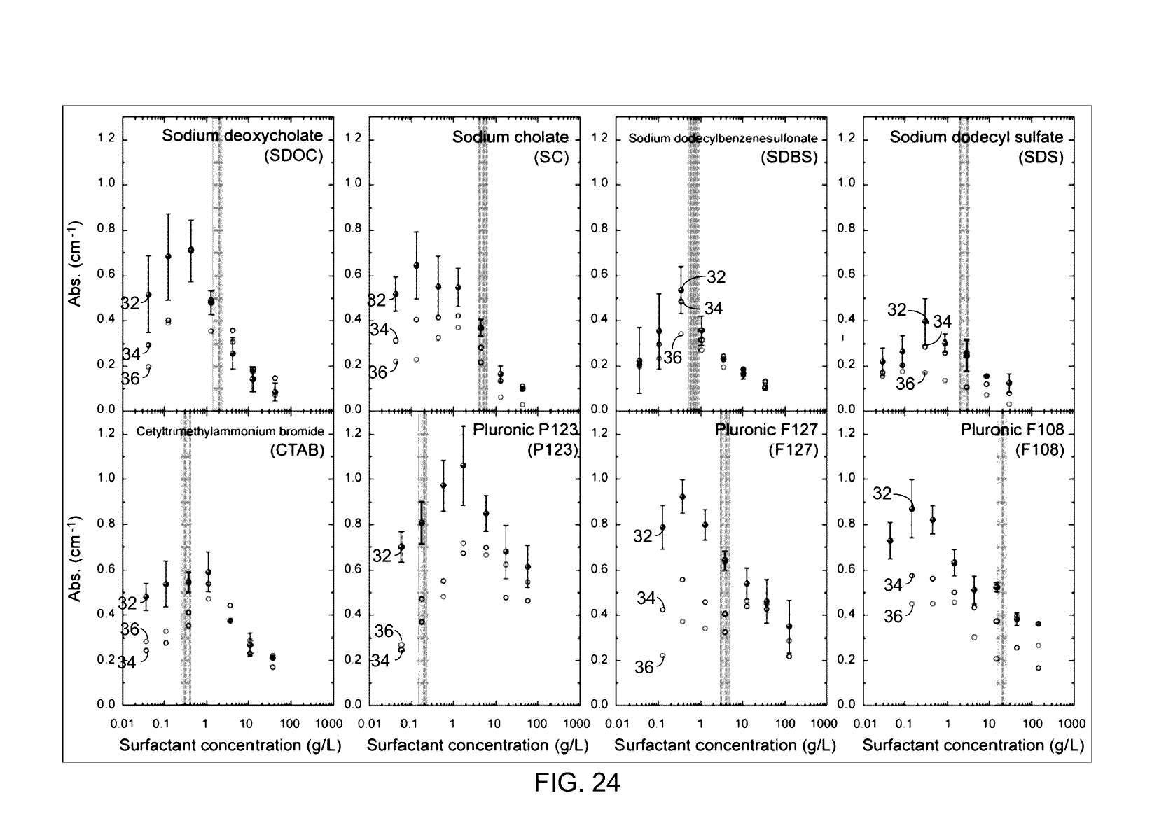

To quantify the minimum energy input required to fully disperse one gram of graphene dry powder into graphene colloidal solution, the total energy per gram of graphene powder, Eₜₒₜₐₗ) is calculated using the specific binding energy, Eₛ, and the surface area, A, of the graphene powder, as follows:

$${E}_{total} = {E}_{s} \frac{( 2600 {m}^{2} - A )}{2} , \qquad ( 3 )$$

wherein 2600 m² is the theoretical maximum surface area, A, per gram of graphene. The specific surface area of the graphene powder can be estimated experimentally from a gas adsorption/desorption isotherm; and the specific binding energy, Eₛ, can be estimated from the interlayer distance, d. The total binding energy, Eₜₒₜₐₗ) provides a practical way to quantify the energy input that is necessary to disperse the graphene from a powder state. It is advantageous to produce graphene dry powder with a larger specific surface area and smaller binding energy. Not only sodium deoxycholate (SDOC), but other surfactant molecules that can effectively reduce the interlayer binding energy between graphene flakes can also be used to produce re-dispersible graphene dry powder. To further illustrate the genericity of this method, eight different surfactants were systematically compared (see FIGS. 24a-h and 25), including the following anionic surfactants: SDOC, sodium cholate (SC), sodium dodecylbenzene sulfonate (SDBS), and sodium dodecyl sulfate (SDS); the following cationic surfactant: cetyltrimethylammonium bromide (CTAB); and the following non-ionic surfactants: poloxamers that are commercially available as PLURONIC P123 (P123), PLURONIC F127 (F127), and PLURONIC F108 (F108) manufactured by BASF Corporation of Ludwigshafen Germany (purchased from Sigma-Aldrich of St. Louis, Mo., USA). The shaded band in each plot of FIGS. 24a-h indicate the surfactant concentrations that produce a critical micelle concentration. For each surfactant, seven different concentrations across three orders of magnitudes were tested to ensure the optimized concentration is covered. A wide concentration range for each surfactant was tested to baseline the performance of different surfactants at their optimized concentration and to make the performance of the eight surfactants more comparable. This effort enabled identification of the better performing surfactant in a more systematic way. The process started with sonication-assisted exfoliation of graphite into graphene in a corresponding surfactant solution. In a typical exfoliation experiment, 10 mg of graphite flake (Alfa Aesar natural, −1.0 mesh, 99.9%, #43319) was added into a 20 mL glass vial containing 10 mL surfactant aqueous solution. The initial graphite dose was kept at 0.1 wt %, and the ultra-sonication treatment (using a BRANSON 2510 bath sonicator from Branson Ultrasonics of Danbury Conn., USA) was performed for one hour. In many cases, the exfoliation creates a vast increase in available surface area, resulting in the rapid depletion of the surfactant from solution through adsorption; and, hence, the corresponding increase in liquid-vapor surface tension is observed. In this case, the low graphite loading of 1 mg/ml and short ultra-sonication duration of one hour ensured that surfactant adsorption on exfoliated graphene was insignificant, allowing maintenance of a constant solution surface tension during the exfoliation process.

Before each batch of ultra-sonication treatment, the sonicator was refilled with 1 L of distilled water at 20±1° C. The water temperature rose to 40±2° C. at the end of the one-hour sonication. After sonication, the solution was centrifuged (using an EPPENDORF 5804 R microcentrifuge) at a relative centrifugal force of 500 g (1700 round per minute) for 20 minutes, the supernatant was carefully collected as the graphene product without disturbing the sediment. The absorbance of the obtained graphene solution using SDOC as the surfactant is plotted as dots 32 versus the surfactant concentration in FIG. 24a. An interesting discovery was that, for each surfactant, there is an optimized concentration for exfoliation, where higher or lower surfactant concentration results in lower graphene absorbance. This volcano-shaped surfactant performance as a function of its concentration was reported previously for and SDBS and SC, and an understanding of this performance is set forth, below.

As the stabilizer for graphene, the surfactant typically has a dual role. First, the surfactant lowers the liquid-vapor interfacial energy, also indicated as the surface tension, of the solution, e.g., to an optimum range corresponding to the energy required to separate the sheets beyond the range of the van der Waals forces. That is, the work of cohesion of the aqueous phase and the sheets of graphene within the graphite solid are comparable. Second, the charged surfactant adsorbs onto the exfoliated graphene sheets, creating an extra electrostatic repulsive term that prevents the re-aggregation of the sheets in the solution. Starting from pure water with a surface tension of ˜73 mN·m⁻¹, addition of surfactant decreases the surface tension until it reaches the optimum value of ˜40 ml·m⁻¹ for graphene dispersion.

Moreover, the surfactant also increases the surface charging of graphene due to adsorption of more surfactant ions on graphene. This absorption explains the rise of graphene production when surfactant concentration increases from zero to the optimum concentration. Further increases in surfactant concentration induces two negative affects to graphene dispersion. On one hand, surface tension is hence reduced to such an extent that exfoliation is not preferable because the energies are no longer matched. On the other hand, for ionic surfactants, addition of surfactant increases the ionic strength of the solution, thus compressing the Debye length of the electrical double layer on the graphene surface, and screening the graphene surface charge that is a consequence of the adsorption of surfactant ions. The compressed Debye length reduces the range of electrostatic repulsion, and the screened surface charge lowers the electrostatic barrier height. These effects explain the drop of graphene production when the concentration is further increased to higher than the optimum concentration. From the results reported here, all of the surfactants followed the volcano-shaped surfactant performance as a function of concentration.

As a reference, our results for SC and SDBS show similar optimized surfactant concentrations of ˜0.1 g/L and ˜0.4 g/L, respectively, as the works reported in M. Lotya et al., “Liquid Phase Production of Graphene by Exfoliation of Graphite in Surfactant/Water Solutions,” 131J. Am. Chem. Soc. 3611-3620 (2009) and “High-Concentration Surfactant-Stabilized Graphene Dispersions”, 4 AC S Nano 3155-3162 (2010).

To investigate the re-dispersity of surfactant-stabilized graphene, the water was removed, and the exfoliated graphene sample was made into dry powder using the same two methods, described above. Then, the same amount of water was added, and the concentration of graphene that is re-dispersed is quantified. Each of the dried samples was added with 3 mL of de-ionized (DI) water, ultra-sonicated for one minute, and centrifuged at 500 g for 20 minutes; and the supernatant was collected for absorbance measurement. The absorbance of the re-dispersed graphene stabilized using different concentrations of SDOC was plotted with circles 34 for freeze-dried samples and with circles 36 for oven-dried samples in FIG. 24a. In this figure, for a low SDOC concentration of 0.04 g/L, the absorbance of the freeze-dried and re-dispersed graphene is 0.3, slightly higher than that of the oven-dried and re-dispersed sample (0.2). After re-dispersement, however, both of the graphene samples, had an absorbance around half of that of pristine graphene (0.5). For the higher SDOC concentration of 0.12 g/L, the absorbance of both freeze-dried and oven-dried samples (both at 0.4) exceeded half of the absorbance of the pristine graphene (0.7). Further increasing the SDOC concentration results in the same absorbance of the re-dispersed graphene as is found with the pristine graphene. If we define the ratio between the absorbance of the re-dispersed sample to the pristine sample as the re-dispersion ratio, we can conclude from FIG. 24a that the redispersity depends strongly on the concentration of the stabilizing surfactant, but only weakly on the way the sample was dried. Similar performance was observed for the other surfactants, as shown in FIGS. 24b-h.

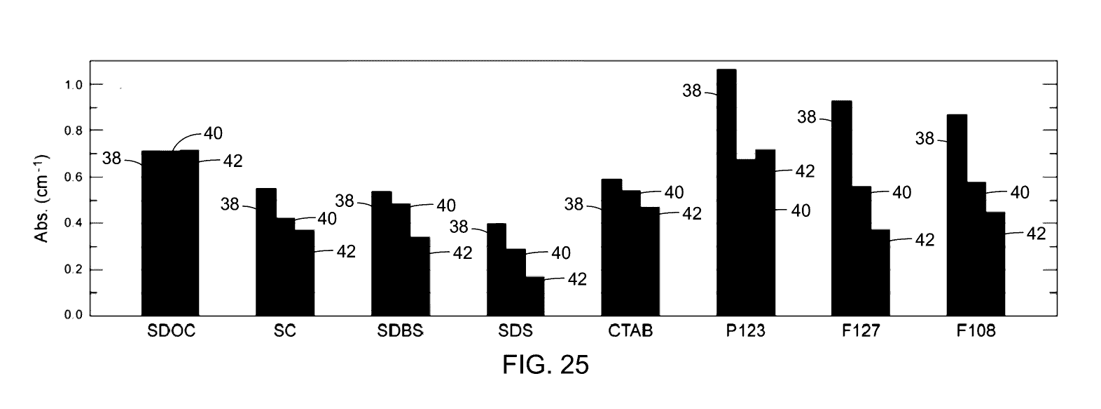

To compare the re-dispersion performance for different surfactants, the highest absorbance of the exfoliated graphene was selected for each surfactant; and the data is plotted in FIG. 24 with bars 32. The absorbance of the corresponding re-dispersed graphene solution was also plotted with circles 34 for freeze-dried samples and with circles 36 for the oven-dried samples. FIG. 25, which plots absorbance for exfoliated graphene 38, absorbance for freeze-dried and re-dispersed graphene 40, and absorbance for oven-dried and re-dispersed graphene 42, indicates that P123 poloxamer is the best surfactant when only considering the exfoliation performance. However, the re-dispersed graphene stabilized by P123 poloxamer show ˜70% absorbance compared to the pristine exfoliated graphene. The re-dispersed samples stabilized by SDOC and P123 poloxamer show similar absorbance. However, the re-dispersity of SDOC-stabilized graphene is ˜100%, outreaching that of P123 poloxamer.

In conclusion, we have demonstrated a general guideline to make graphene dry powder that can be easily re-dispersed by, e.g., one-minute ultra-sonication. Freeze-dried graphene powder was found to re-disperse better than graphene powder obtained from thermal solvent evaporation. Adding surfactant will further increase the re-dispersity. The overall energy input needed to re-disperse the graphene flakes was modeled theoretically, from which the energy landscape can be simplified into two variables, the interlayer binding energy and the specific surface area. The less energy input that is needed, the easier the re-dispersion. The model confirms that graphene dry powder with larger specific surface area and smaller interlayer binding energy exhibit less overall binding energy and is, therefore, easier to disperse. The generality of the re-dispersion method was further compared experimentally by using surfactant molecules other than SDOC. The results shown that both SDOC and P123 triblock copolymer (HO(CH₂CH₂O)₂₀(CH₂CH(CH₃)O)₇₀(CH₂CH₂O)₂₀H) perform well in stabilizing the graphene flakes and making them into re-dispersible powders.

Additional examples consistent with the present teachings are set out in the following numbered clauses:
1. A method for producing re-dispersible dry graphene powder, comprising:
   producing a solution of graphene sheets in solvent; adding surfactant to the solution; and then
   drying the solution to produce dry graphene sheets coated with surfactant.
2. The method of clause 1, wherein the graphene sheets are preserved in a substantially non-oxidized form throughout the method.
3. The method of clause 1 or 2, further comprising shipping the graphene sheets as a dry powder.
4. The method of any of clauses 1-3, wherein the surfactant comprises at least one of sodium deoxycholate and a poloxamer.
5. The method of any of clauses 1-4, wherein the solvent includes at least one of isopropyl alcohol and n-methylpyrrolidone.
6. The method of any of clauses 1-5, further comprising exfoliating graphene sheets from graphite to produce the solution.
7. The method of any of clauses 1-6, wherein the graphene sheets are dried by freeze drying.
8. The method of any of clauses 1-7, comprising, after drying the solution, re-dispersing the graphene sheets in solvent to form a second solution.
9. The method of clause 8, further comprising subjecting the graphene powder and solvent to ultra-sonication or shear mixing for no more than about one minute to form the second solution.
10. The method of clause 8 or 9, wherein the re-dispersion ratio of the graphene sheets in the second solution is greater than 0.80.
11. A re-dispersible graphene powder, comprising:
   dry, substantially non-oxidized graphene sheets; and
   a surfactant coating on the graphene sheets.
12. The re-dispersible graphene powder of clause 11, wherein the surfactant comprises at least one of sodium deoxycholate and a poloxamer.
13. The re-dispersible graphene powder of clause 11 or 12, wherein a majority of the graphene sheets have a thickness in a range from 1 nm to 6 nm.
14. The re-dispersible graphene powder of any of clauses 11-13, wherein the re-dispersion ratio of the graphene sheets is at least 0.82 with a graphene concentration as high as 1 mg/mL in solvent.
15. The re-dispersible graphene powder of any of clauses 10-14, wherein the graphene powder is produced by the method of any of clauses 1-10.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties or other values are specified herein for embodiments of the invention, those parameters or values can be adjusted up or down by 1/100^{th}, ⅕^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

what is claimed is:

1. A method for producing re-dispersible dry graphene powder, comprising:
producing a solution of graphene sheets in solvent;
adding surfactant to the solution; and then
drying the solution to produce dry graphene sheets coated with surfactant.

2. The method of claim 1, wherein the graphene sheets are preserved in a substantially non-oxidized form throughout the method.

3. The method of claim 1, further comprising shipping the graphene sheets as a dry powder.

4. The method of claim 1, wherein the surfactant comprises at least one of sodium deoxycholate and a poloxamer.

5. The method of claim 1, wherein the solvent includes at least one of isopropyl alcohol and n-methylpyrrolidone.

6. The method of claim 1, further comprising exfoliating graphene sheets from graphite to produce the solution.

7. The method of claim 1, wherein the graphene sheets are dried by freeze drying.

8. The method of claim 1, comprising, after drying the solution, re-dispersing the graphene sheets in solvent to form a second solution.

9. The method of claim 8, further comprising subjecting the graphene powder and solvent to ultra-sonication or shear mixing for no more than about one minute to form the second solution.

10. The method of claim 8, wherein the re-dispersion ratio of the graphene sheets in the second solution is greater than 0.80.

11. A re-dispersible graphene powder, comprising:
dry, substantially non-oxidized graphene sheets; and
a surfactant coating on the graphene sheets.

12. The re-dispersible graphene powder of claim 11, wherein the surfactant comprises at least one of sodium deoxycholate and a poloxamer.

13. The re-dispersible graphene powder of claim 11, wherein a majority of the graphene sheets have a thickness in a range from 1 nm to 6 nm.

14. The re-dispersible graphene powder of claim 10, wherein the re-dispersion ratio of the graphene sheets is at least 0.82 with a graphene concentration as high as 1 mg/mL in solvent.
